(19) United States
(12) Patent Application Publication
(10) Pub. No.: US 2009/0176195 A1
(43) Pub. Date: Jul. 9, 2009

(54) A+ education classroom to include preschool, headstart, kindergarten, elementary education, elementary special education, junior high regular education, and junior high special education classrooms

(76) Inventor: Ella Delores Davis, Quitman, LA (US)

Correspondence Address: Ella Delores Davis, 271 Sugar Creek Road, Quitman, LA, 71268, US

(21) Appl. No.: 11/973,196

(22) Filed: Oct. 5, 2007

Related U.S. Application Data
(60) Provisional application No. 60/966,373, filed on Aug. 27, 2007.

(51) Int. Cl. G09B 19/00; G09B 29/00; A47B 39/00

(52) U.S. Cl. 434/238; 434/430; 434/432

(57) ABSTRACT

This invention is described as a classroom that will have classroom displays, layouts, and a floor plan to educate students to the maximum, A+ Level. This is an entirely new concept in education.

### CROSS-REFERENCE TO RELATED APPLICATIONS

This application claims the benefit of Provisional Patent Application Ser. No. 60/966,373 filed on Aug. 27, 2007 by the present inventor, Ella Davis.

### BACKGROUND OF THE INVENTION

This invention relates to classroom displays, layouts, and/or floor plans specifically to an improved classroom display, layout, or floor plan to educate students in preschool, headstart, kindergarten, elementary education, elementary special education, junior high regular education, and junior high special education to the maximum regardless of the educational level/background or environmental circumstances.

### BRIEF SUMMARY OF THE INVENTION

The design, layout, and/or floor plan of the A+ Education Classroom will allow educators to maximize the educational potential of learners to the fullest degree—A+ Level.

The advantages of this invention is that in most classrooms you have students on grade level, below grade level, and in some cases above grade level. Some students' family are below or at the poverty level or some are financially secure. Regardless of the educational performance or economic level, each student will have the opportunity to work toward their fullest potential—A+ Level.

### BRIEF DESCRIPTION OF DRAWINGS

FIG. 1 is a drawing of reporting progress displays to include FIG. 1A which shows a Progress Card, FIG. 1B which shows a Progress Report Star, and FIG. 1C shows a Report Card Star.

FIG. 2 shows a side view of the far wall as you enter The A+ Education Classroom.

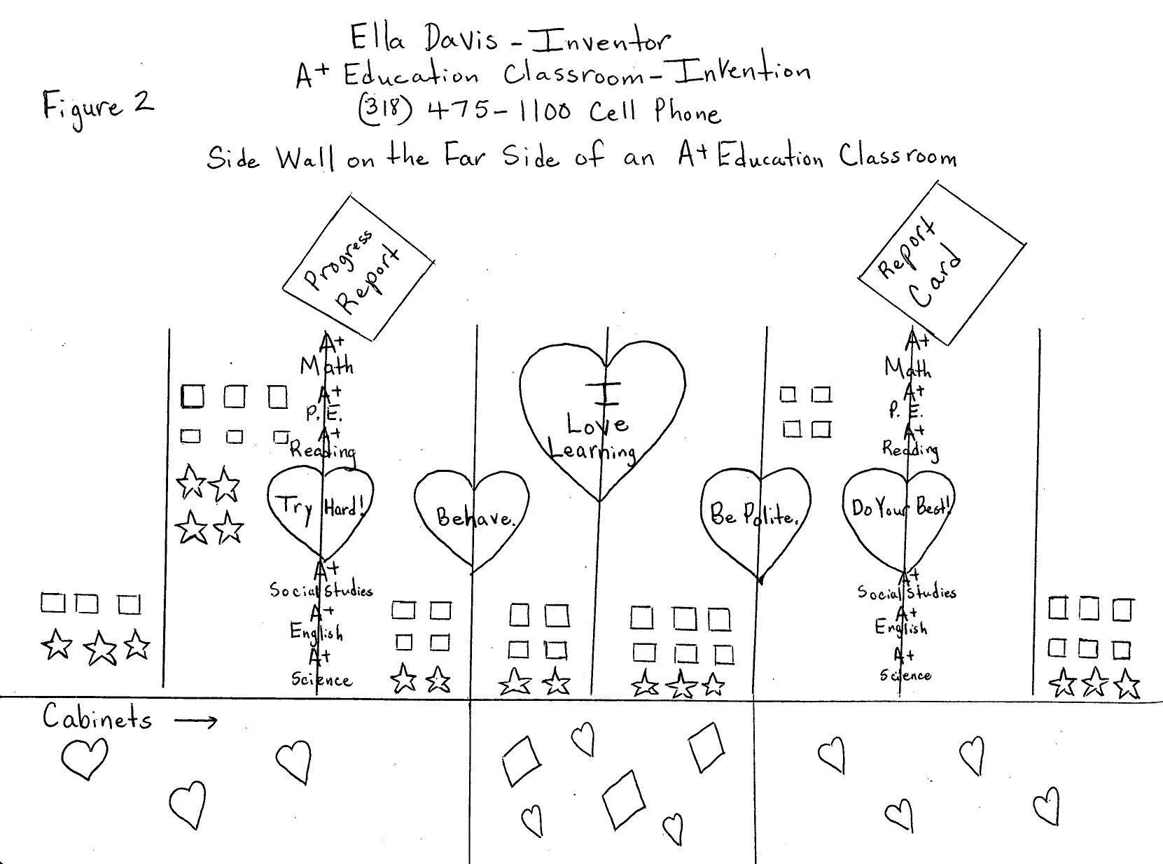

FIG. 3 shows the front wall view of The A+ Education Classroom.

FIG. 4 is the side wall as you enter The A+ Education Classroom.

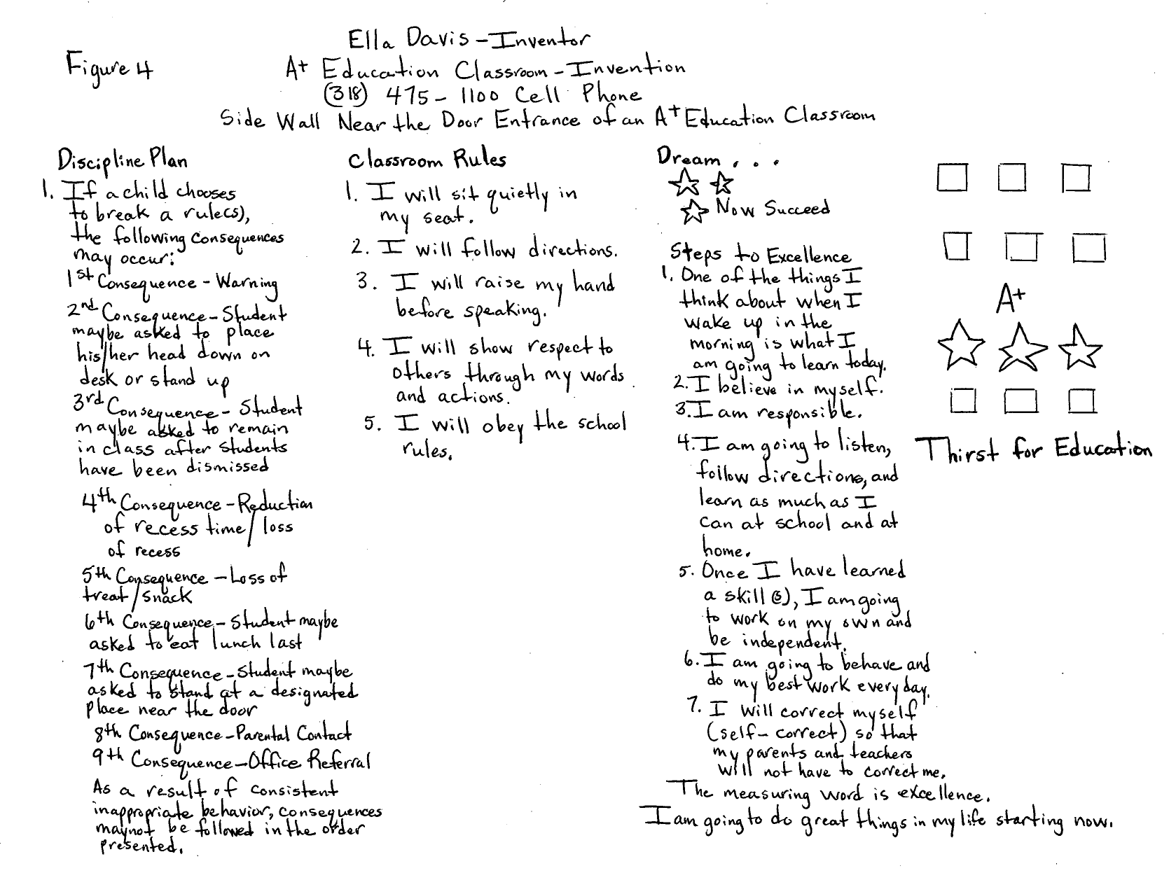

FIG. 5 is the back wall view as you enter The A+ Education Classroom.

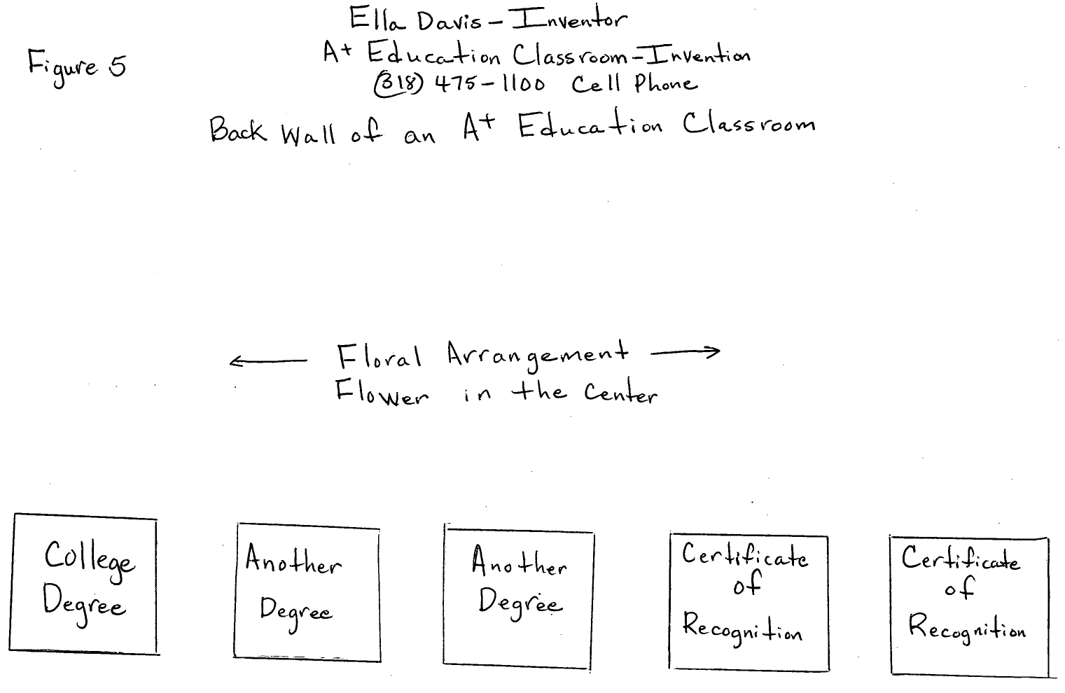

FIG. 6 shows the floor plan for The A+ Education Classroom.

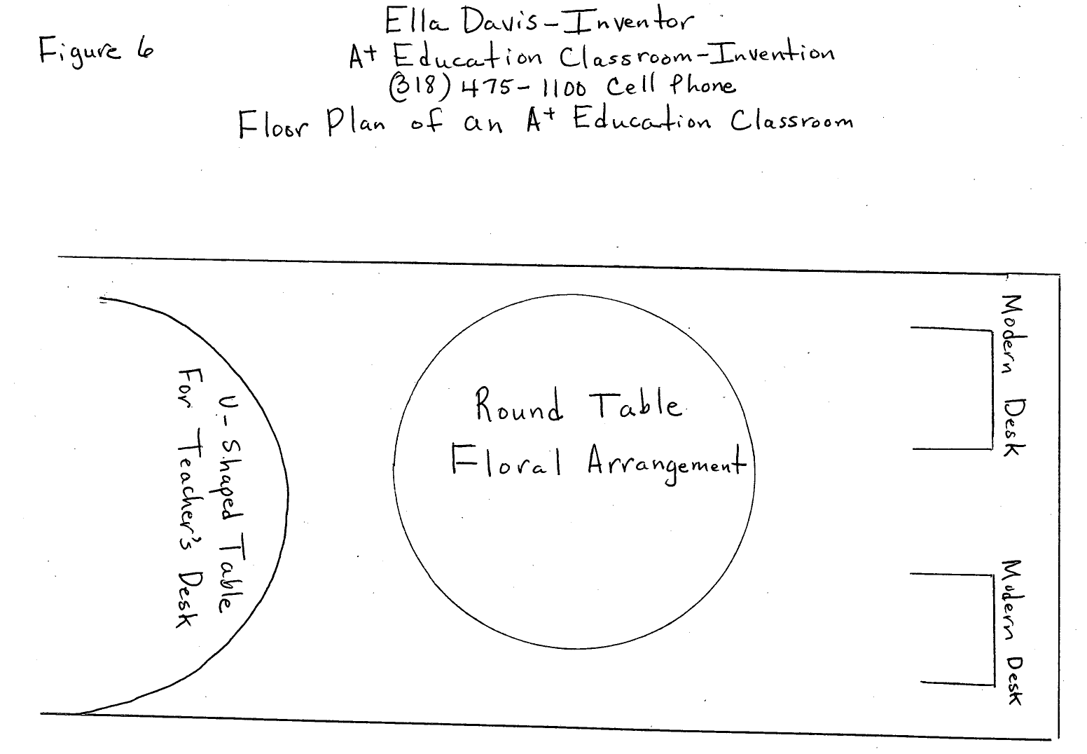

### DETAILED DESCRIPTION OF INVENTION

### Specification

I can take a classroom and set it up an A+ Education Classroom in the following manner:

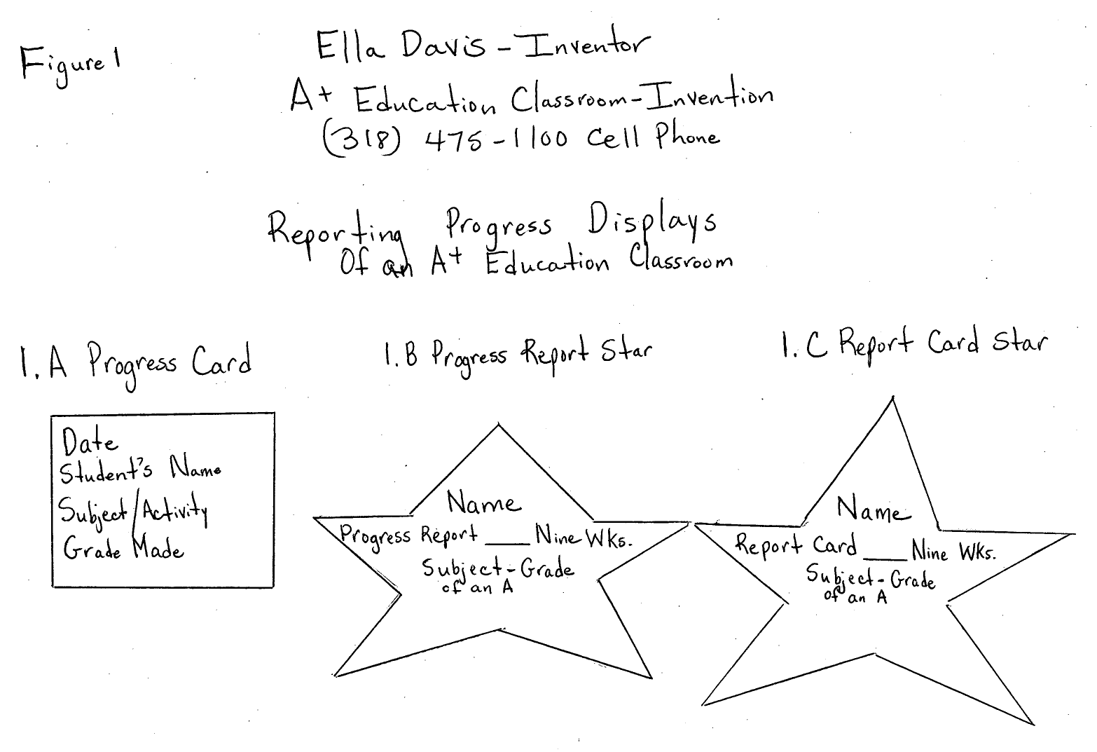

Each student has a space on the wall to write down each grade of an A made during the school year. A+ work completed for the school year will be displayed in the classroom on progress cards, progress report stars, or report card stars. A progress card, progress report star, and report card star is illustrated in figure one—see FIGS. 1A, 1B, and 1C. On the far side wall as you enter the classroom, an example of an A+ Progress Report and A+ Report Card is displayed with all A's. Displays including I Love Learning, Try Hard, Behave, Be Polite, and Do Your Best are shown on this far side wall as you enter The A+ Education Classroom. Small progress note cards are used to document A's made on classroom activities completed in the classroom. Stars are used to document A's made on a progress report and report card. On the center cabinet of this far side wall in The A+ Education Classroom, there is a display of hearts and books. On both sides of the center cabinet are pictures of hearts on the cabinets. See figure two for an illustration of this far side wall as you enter The A+ Education Classroom.

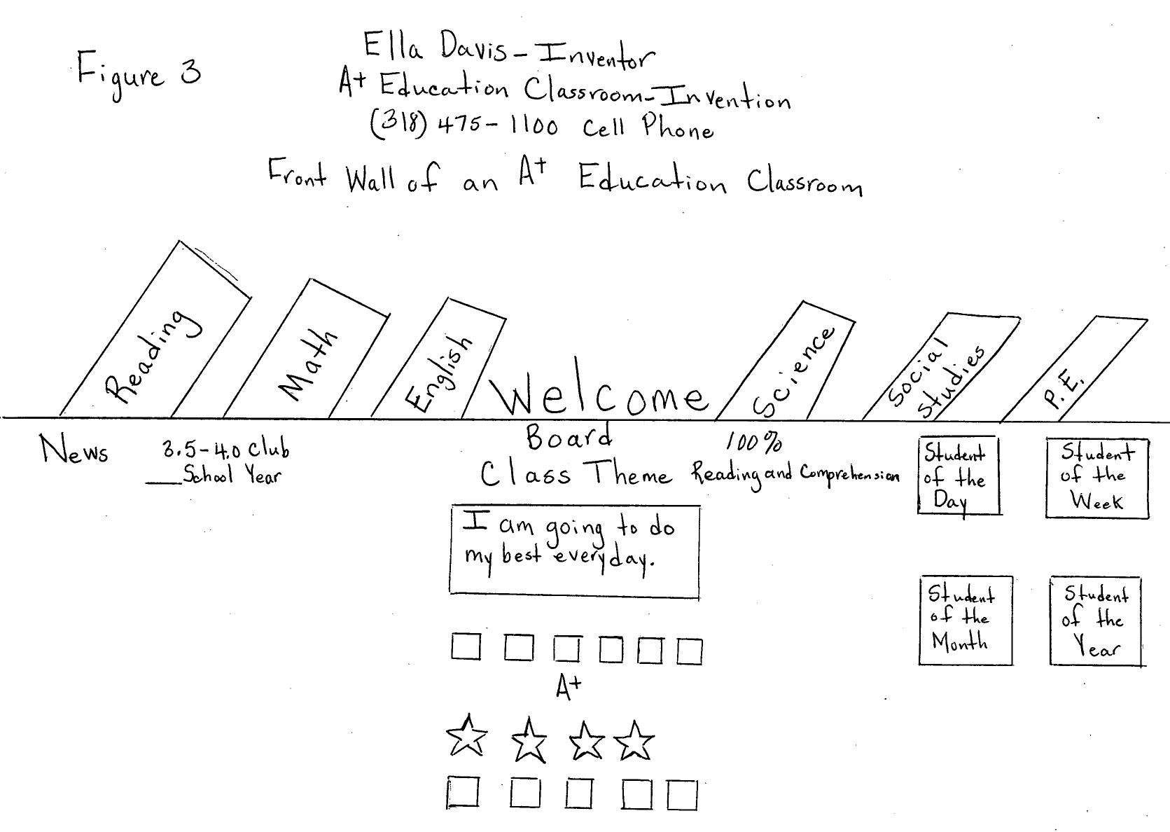

The front wall of The A+ Education Classroom has a chalkboard (preferably white) for writing information. The upper wall of this area should display the welcome sign as well as a display of books of all the subject areas that will be taught during the school year. News concerning the accomplishments of the students as well as 3.54.0 Club, Class Theme (I am going to do my best everyday.), Reading and Comprehension at 100%, Student of the Day, Student of the Week, Student of the Month, and Student of the Year are shown. Information concerning vo-technical schools and colleges is displayed in order that students may begin to think about educational opportunities after high school. Display space on the board may be used by using progress cards, progress report stars, and report card stars to put additional A+ work done by students. See FIG. 3 for an illustration of this front wall of The A+ Education Classroom.

The side wall as you enter The A+ Education Classroom displays the Discipline Plan, Classroom Rules, Steps to Excellence, and Dream . . . Now Succeed, and Thirst for Learning areas. This side wall may be used to display additional A+ Work done by students by using progress cards, progress report stars, and report card stars. This side wall as your enter The A+ Education Classroom is illustrated by figure four.

The back wall of The A+ Education Classroom shows a display of the credentials of the educator along with a floral display. All of the degrees and certificates of recognition in education may be displayed on the back wall. The back wall of The A+Education Classroom is illustrated by the picture from figure five.

The floor area of The A+ Education Classroom should consist of modern type desks. The center of the classroom should have a round table with a floral arrangement on the table. The teacher's desk should consist of a u-shaped table with chairs around the table for students to sit around the table to receive instruction. See figure six for an illustration of the floor plan of The A+ Education Classroom.

1. What I claim as my invention is the contents, layout, and design of The A+Education Classroom to include classrooms in preschool, headstart, kindergarten, elementary education, elementary special education, junior high regular education, and junior high special education classes.

2. The A+ Education Classroom of claim 1 wherein an example of an A+ Progress Report and Report Card Display to include an example of a progress report and report card with all A's.

3. The A+ Education Classroom of claim 1 wherein The Progress Card, Progress Report Star, and Report Card Star which is used for reporting/displaying progress of students is displayed on all of the walls.

4. The A+ Education Classroom of claim 1 wherein The I Love Learning Display to foster the enjoyment of getting an education.

5. The A+ Education Classroom of claim 1 wherein The Try Hard Display which lets the learners know that effort needs to be put forth to learn.

6. The A+ Education Classroom of claim 1 wherein The Be Polite Display which encourages students to use manners.

7. The A+ Education Classroom of claim 1 wherein The Do Your Best Display which motivates students to do all that they can do to learn.

8. The A+ Education Classroom of claim 1 wherein The Books and Heart Display on the center cabinet and The Heart Display on both sides of the center cabinet.

9. The A+ Education Classroom of claim 1 wherein The Display of Books to include the subject matter that will be taught that school year.

10. The A+ Education Classroom of claim 1 wherein The News Display to recognize the accomplishments of students throughout the school year.

11. The A+ Education Classroom of claim 1 wherein The 3.54.0 Club Display to show the high achievers in class.

12. The A+ Education Classroom of claim 1 wherein The Class Theme Display (I am going to do my best everyday.) which serves as a guide for the effort that students should put forth everyday.

13. The A+ Education Classroom of claim 1 wherein The Reading and Comprehension @ 100% Display which shows the name of students who read the weekly story at 100% reading and comprehension.

14. The A+ Education Classroom of claim 1 wherein The Student of the Day, Student of the Week, Student of the Month, and Student of the Year Display which are certificates/awards that the students may earn as result of working well and behaving in class.

15. The A+ Education Classroom of claim 1 wherein The Vo-Technical/College Display which includes information concerning area vo-technical schools and area colleges in order for students to think about future plans.

16. The A+ Education Classroom of claim 1 wherein The Discipline Plan Display which is used to help students realize that there are consequences to inappropriate behavior and The Classroom Rules Display which has the guidelines for how the class will be managed by the educator.

17. The A+ Education Classroom of claim 1 wherein The Steps to Excellence Display with encouraging steps for students to use even at an early age to achieve excellence and Dream . . . . Now Succeed Display which encourages students to dream of what he/she wants to do in life and work toward fulfilling those dreams everyday by working hard to succeed.

18. The A+ Education Classroom of claim 1 wherein The Thirst for Learning Display to include stories of people that succeeded against the odds by getting a good education.

19. The A+ Education Classroom of claim 1 wherein The Display of the Credentials of the Educator in which the educators should display credentials to show the qualifications and education of the educator and educator can serve as a roll model for the students and the floral arrangement on the back of the wall with The Credentials of the Educator Display which adds to the décor of the classroom.

20. The A+ Education Classroom of claim 1 wherein The Floor Plan which includes modern type desks should be placed in the front of the classroom. A round table with a floral arrangement should be in the center of the table. A u-shaped table should be placed at the back of the room for the teacher to use as a desk and for students to use as a work area.
